(19) United States
(12) Patent Application Publication
(10) Pub. No.: US 2012/0164416 A1
(43) Pub. Date: Jun. 28, 2012

(54) COATING FOR THERMOELECTRIC MATERIALS AND A DEVICE CONTAINING THE SAME

(76) Inventors: Lin He, Horseheads, NY (US); Lidong Chen, Shanghai (CN); Xiangyang Huang, Shanghai (CN); Xiaoya Li, Shanghai (CN); Xugui Xia, Shanghai (CN)

(21) Appl. No.: 13/386,732

(22) PCT Filed: Jul. 27, 2010
(86) PCT No.: PCT/US10/43317

§ 371 Date: Feb. 21, 2012

(30) Foreign Application Priority Data
Jul. 27, 2009 (CN) 200910055439.3

(51) Int. Cl. B32B 7/02; B32B 3/00; B32B 15/04

(52) U.S. Cl. 428/213; 428/472; 428/336

(57) ABSTRACT

A coating for thermoelectric materials includes a thermoelectric layer having a thermoelectric material, a metal coating of one or more layers forming a surface in contact with the thermoelectric layer and an opposing surface, and a metal oxide coating of one or more layers including metal oxides, wherein the metal oxide coating forms a surface in contact with the opposing surface. A device comprises the material and a process for fabricating the same.

### CROSS-REFERENCE TO RELATED APPLICATIONS

This application claims priority to Chinese Patent Application number 200910055439.3, filed Jul. 27, 2009, titled “A Coating For Thermoelectric Materials and A Device Containing The Same.”

### TECHNICAL FIELD

Disclosed herein is a thermoelectric material coating as well as the structure and the fabricating process of an element (or device) comprising the material in the field of thermoelectric materials and devices.

### BACKGROUND

Thermoelectric power generation is a power generation technology which takes advantage of the Seebeck effect of semiconducting thermoelectric materials to accomplish direct conversion of thermal energy (temperature difference) to electric energy. A thermoelectric power generation system has a compact structure, reliable performance and superior mobility. In addition, it does not suffer from any noise, abrasion or leakage in operation for it has no operational elements. As an environmentally friendly energy technology, thermoelectric power generation is suitable for recycling energy of low density, and thus wide applications thereof may be envisaged for recycling residual heat from industry and waste heat from car tail gas. Thermoelectric conversion efficiency is mainly determined by the dimensionless performance index of the materials: ZT=S²σT/κ, wherein S represents Seebeck coefficient, σ represents electric conductivity, κ represents thermal conductivity, and T represents absolute temperature. A higher ZT value of the materials means a higher thermoelectric conversion efficiency.

Owing to large crystal cells, heavy atomic mass, large carrier mobility and disturbance of filled atoms in Sb dodecahedron, thermoelectric materials of CoSb₃ based skutterudite exhibit superior high temperature thermoelectric properties at 500-850K, wherein the ZT maxima of n-type Yb_{y}CO₄Sb₁₂ (800K) and p-type CaₓCe_{y}CO_{2.5}Fe_{1.5}Sb₁₂ (750K) are 1.4 and 1.2 respectively. Regarding comprehensive properties, price, safety and fabricating processes, CoSb₃ based skutterudite, among the plurality of new thermoelectric material systems, is the most promising medium to high temperature thermoelectric material for commercial use, and is expected to replace PbTe thermoelectric materials in popular use currently.

Since the optimal thermoelectric properties of CoSb₃ based skutterudite thermoelectric materials are achieved at 500-850K, the operation temperature of the thermoelectric elements adjacent to the high temperature end in a CoSb₃ based skutterudite thermoelectric device may be up to 850K. The vapor pressure of element Sb is very high at high temperatures (FIG. 1), for example, about 10 Pa at 850K, 12 orders of magnitude higher than those of elements Fe, Co, Ce and the like (David R. Lide, CRC Handbook of Chemistry and Physics, CRC Press, 2005), leading to serious degradation of the properties of the thermoelectric device due to the loss of element Sb at high temperatures.

The surface of a thermoelectric material has to be encapsulated by coating to avoid degradation of the device properties due to evaporation of the material during high temperature operation. Such a measure of coating protection of thermoelectric materials in an operational environment of high temperature may be dated back to more earlier SiGe thermoelectric materials. The high temperature end of a SiGe thermoelectric device may reach a temperature of 1273K. SiGe thermoelectric materials may be protected properly by applying a Si₃N₄ coating having a thickness of millimeters (Kelly C. E. Proceedings of the 10th intersociety energy conversion engineering conference, American Institute of Chemical Engineers, New York 1975, P. 880-6). In an attempt to solve the problem of high temperature evaporation of Sb in CoSb₃ based skutterudite thermoelectric materials, a method of applying a metal coating on the surface of a skutterudite material is proposed by Mohamed (Mohamed S. El-Genk et. al. Energy Conversion and Management, 47 (2006) 174; Hamed H. Saber, Energy Conversion and Management, 48 (2007) 1383). Metal elements suggested for use in the coating for a segment device (p-type element: CeFe₃₅CO_{0.5}Sb₁₂+Bi_{0.4}Sb_{1.6}Te₃, n-type element: CoSb₃+Bi₂Te_{2.95}Se_{0.05}) include Ta, Ti, Mo and V. The thickness of a metal coating is supposed to be 1-10 μm. According to theoretical deduction, the higher the electric conductivity of a metal coating or the larger the thickness of the coating, the higher the peak output power, but the lower the peak conversion efficiency. Neither the process for preparing coatings nor the comparison between the experimental data of the four coatings is mentioned in the paper of Mohamed.

Though the method proposed by Mohamed to apply a metal coating on the surface of a CoSb₃ based skutterudite material having specific components indicates a direction to solve the problem of evaporation of Sb at high temperatures, the scope covered by the method is rather narrow, and the problem of high temperature oxidation in the practical environment confronted by the CoSb₃ based skutterudite material and the elements comprising the material has not been solved.

Therefore, there is an urgent need in the art for a coating, which may be used for a thermoelectric material and may solve the problem of high temperature oxidation, as well as a device comprising the material.

### SUMMARY

According to a first embodiment, a coating may be used for a thermoelectric material and may solve the problem of high temperature oxidation. According to a second embodiment, a device is disclosed which comprises the material and may solve the problem of high temperature oxidation. In yet a further embodiment, a fabricating process for forming the thermoelectric material is disclosed, and may solve the problem of high temperature oxidation.

Disclosed herein is a coating, comprising a thermoelectric layer comprising a thermoelectric material, a metal coating of one or more layers forming a surface in contact with said thermoelectric layer and an opposing surface, and a metal oxide coating of one or more layers comprising metal oxides, wherein said metal oxide coating forms a surface in contact with said opposing surface.

In a specific embodiment, the thermoelectric material is selected from filled and/or doped skutterudite.

In a specific embodiment, the filled and/or doped skutterudite is selected from CoSb₃ based skutterudite.

In a specific embodiment, the metal coating(s) comprises Ta, Nb, Ti, Mo, V, Al, Zr, Ni, NiAl, TiAl, NiCr or a combination thereof.

In a specific embodiment, the metal oxide coating(s) comprises TiO₂, Ta₂O₅, Nb₂O₅, Al₂O₃, ZrO₂, NiO, SiO₂ or a combination thereof.

In a specific embodiment, the coating has a thickness of 10-500 μm, for example 50-200 μm.

In a specific embodiment, the metal coating(s) has a thickness of 0.01-20 μm (microns), for example, 0.2-2 μm (microns).

In a specific embodiment, the thermoelectric layer has a thickness of L_{T}, and the metal coating(s) the said metal oxide coating(s) each has a thickness of L_{M&MOx}, wherein L_{M&MOx}≦L_{T}, and (L_{T}−L_{M&MOx})/L_{T}≦0.4.

In a further embodiment, there is disclosed a device comprising the coating.

In a still further embodiment, a process for fabricating the coating comprises providing a thermoelectric layer comprising a thermoelectric material, forming a metal coating of one or more layers on said thermoelectric layer, wherein said metal coatings forms a surface in contact with the thermoelectric layer as well as an opposing surface, and forming a metal oxide coating of one or more layers on said metal coating(s), wherein said metal oxide coatings comprise metal oxides and form a surface in contact with said opposing surface of said metal coating(s).

In some embodiments, all or a portion of said metal coatings are formed by thermal evaporation, arc spraying, plasma spraying, flame spraying, vacuum sputtering, electrochemical vapor deposition, electric plating or electroless deposition.

In some embodiments, all or a portion of said metal oxide coatings are formed by thermal evaporation, vacuum sputtering, plasma spraying, sol-gel, chemical solution deposition or chemical vapor deposition.

In some embodiments, at least part of said metal coating is oxidized to contact said metal oxide coating with said opposing surface of said metal coating.

### BRIEF DESCRIPTION OF THE DRAWINGS

FIG. 1 shows the high temperature vapor pressures of some elements;

FIG. 2 shows a π-type device of CoSb₃ based skutterudite having multiple coatings;

FIG. 3 shows the top-view cross section of the thermoelectric element covered by multiple encapsulations according to FIG. 2 (left: circular, right: square); and

FIG. 4 shows the SEM image of the interface between the Yb_{0.3}Co₄Sb₁₂ core and the encapsulation.

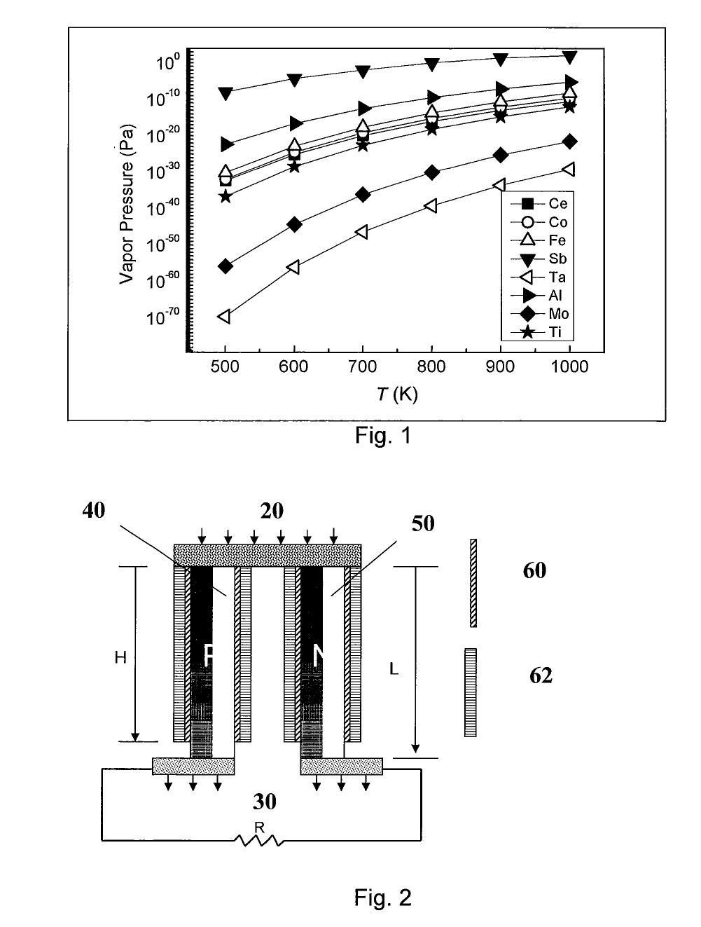

### DETAILED DESCRIPTION

After extensive and intensive study, the present inventors have solved both problems of Sb evaporation and material oxidation at high temperatures as mentioned above and have improved both durability and reliability of CoSb₃ based skutterudite materials and devices made therefrom by modifying the fabricating processes to form two classes of multiple coatings, namely metal and metal oxide coatings, on the surface of a thermoelectric material (typically a CoSb₃ based skutterudite material) using physical and chemical means.

For application requirements of a thermoelectric material and an element made therefrom, two classes of multiple coatings, namely metal and metal oxide coatings, are formed on the surface of the CoSb₃ based skutterudite material or the element using a physical or chemical coating forming process to prevent Sb from evaporation and material oxidation at high operation temperatures.

Disclosed is a process for fabricating a thermoelectric material having a structure of multiple coatings as well as an element thereof in the field of thermoelectric materials and devices. The composition of the material may be described as SKT/M/MOₓ, wherein SKT includes, but is not limited to, CoSb₃ based skutterudite compounds, doped CoSb₃ based skutterudite compounds, CoSb₃ based filled skutterudite compounds, doped CoSb₃ based filled skutterudite compounds, M represents a metal coating, including but not limited to one of Ta, Nb, Ti, Mo, V, Al, Zr, Ni, NiAl, TiAl, NiCr or an alloy of two or more of them, and MOₓ represents a metal oxide coating, including but not limited to one of TiO₂, Ta₂O₅, Nb₂O₅, Al₂O₃, ZrO₂, NiO, SiO₂, or a composite of two or more of them, or a multi-layer structure of two or more of them. The material or element as represented by SKT/M/MOₓ has a concentric structure of multiple encapsulations.

In other words, the SKT material is encapsulated at its surface by a layer of metal M, and the M layer is further encapsulated at its surface by one or more layers of MO_{X}. The encapsulations function to prevent Sb in SKT from evaporation and SKT material from oxidation. The main role of the metal M layer lies in the improvement of compactness, consistency and binding strength of the MOₓ encapsulation. The processes for fabricating encapsulations include thermal evaporation, physical sputtering, arc spraying, plasma thermal spraying, electrochemical vapor deposition, chemical vapor deposition, solution chemical vapor deposition, pulse electric deposition and the like. The total thickness of the coatings is typically 10-500 μm, wherein the thickness of the M layer 0.01-20 μm, and that of the MOₓ layer is 9.99-499.9 μm.

The process can be used to fabricate a CoSb₃ based skutterudite material having a concentric multi-layer structure which is effective in avoiding Sb evaporation and SKT oxidation at high temperatures. As indicated by the results of high temperature aging, the conversion efficiency of an encapsulated π-type element remains substantially unchanged after 1000 hours of high temperature aging test, while that of the unencapsulated version of the same π-type element decreases by 70% after 1000 hours of aging. The disclosed approach has remarkably enhanced the durability of the CoSb₃ based skutterudite material and the device made therefrom, which may work for an extended time at a temperature ranging from room temperature to 600° C. as a practical thermoelectric material and a practical device respectively.

As used herein, “opposing” means that two elements involved are facing each other in terms of position relationship.

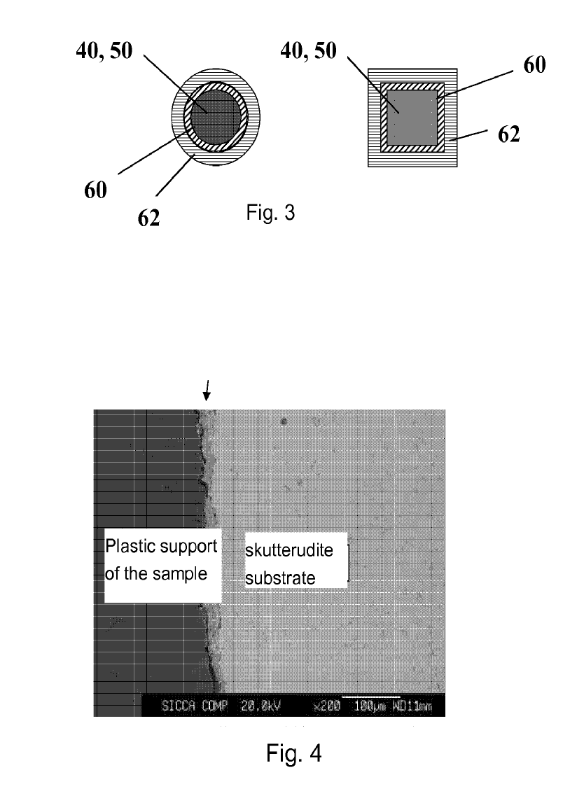

FIGS. 2 and 3 show an element and coatings thereof having a coated concentric multi-layer structure, wherein the general formula of the structure may be described as SKT/M/MOₓ, i.e., a structure of thermoelectric material (SKT)/coatings (M/MOₓ). In FIG. 2 a heat source 20 is separated from a heat sink 30 by a p-type element 40 and an n-type element 50. The height of the elements is L. Formed over each element is a metal coating 60 and a metal oxide coating 62. The height of the metal and metal oxide coatings is H. FIG. 3 shows example cross-sectional elements 40,50 having a Mo metal coating 60 and a ZrO2 oxide coating 62.

SKT may be selected from CoSb₃ based skutterudite materials, doped CoSb₃ based skutterudite compounds, CoSb₃ based filled skutterudite compounds, doped CoSb₃ based filled skutterudite compounds and composite materials with the foregoing compounds as the dominant phase; as well as thermoelectric materials of cage-type compounds, semi-Heusler thermoelectric materials, BiTe based materials, doped BiTe based compounds, BiTe based filled compounds, doped BiTe based filled compounds and composite materials with the foregoing compounds as the dominant phase. Preferably, SKT is selected from CoSb₃ based skutterudite materials, doped CoSb₃ based skutterudite compounds, CoSb₃ based filled skutterudite compounds, doped CoSb₃ based filled skutterudite compounds and composite materials with the foregoing compounds as the dominant phase.

The metal coating M is a thin film coating of a metal or an alloy, including but not limited to one of Ta, Nb, Ti, Mo, V, Al, Zr, Ni, NiAl, TiAl, NiCr or an alloy of two or more of them.

MOₓ is a coating of a metal oxide, including but not limited to one of TiO₂, Ta₂O₅, Nb₂O₅, Al₂O₃, ZrO₂, NiO, SiO₂, or a composite of two or more of them, or a multi-layer structure of two or more of them.

The disclosure provides a process for fabricating a CoSb₃ based skutterudite compound material having multiple coatings and a device made therefrom. The core of the process is the formation of one or more outer oxide layers having strong adhesion, high compactness and good consistency, and the formation of one or more inner metal layers, by a physical or chemical means. The transitional layer of a metal can prevent element Sb from evaporation at high temperatures and enhance the binding strength between the oxide layer and the skutterudite material.

All or a portion of the metal coatings may be formed by thermal evaporation, arc spraying, plasma spraying, flame spraying, vacuum sputtering, electrochemical vapor deposition, electric plating or electroless deposition.

All or a portion of the metal oxide coatings are formed by thermal evaporation, vacuum sputtering, plasma spraying, sol-gel, chemical solution deposition or chemical vapor deposition.

In some embodiments, a filled and/or doped CoSb₃ based skutterudite compound material or element is used as the core, and a process of thermal evaporation, physical sputtering, arc spraying, pulse electric deposition, electrochemical deposition or electric plating among others is used to form one or more transitional layers of M on the surface of the skutterudite material. Then, one or more oxide layers of MOₓ are formed on the surface of the M layer by a process of thermal evaporation, physical sputtering, plasma thermal spraying, sol-gel, chemical solution deposition or chemical vapor deposition among others. With respect to those metal elements which are susceptible to oxidation, a MOₓ layer may also be obtained by direct oxidation of a M layer at an appropriate partial pressure of oxygen, wherein the partial pressure of oxygen and the temperature thereof are the key process parameters for controlling thickness.

Among the two classes of coatings, the inner M transitional coating, having a smaller thickness of 0.01-20 μm, mainly functions to enhance the binding strength of the MOₓ coating. The total thickness of the M layer is determined by the core of the skutterudite material, the components, thermal conductivity and electric conductivity of the M layer itself, the process for forming the M layer, the components of the MOₓ layer, and the like. An approach to controlling the thickness of the M layer is the prevention of any bypass for rapid heat flow and current flow from being formed. The outer preventive coating of MOₓ has a larger thickness which is determined by the components of the material, the process for forming the MOₓ layer, the compactness and thermal conductivity of the MOₓ layer, and the like. The total thickness of the two classes of coatings is 10-500 μm.

If a CoSb₃ based skutterudite material with multiple encapsulations is used as a thermoelectric element to form a device, the length (height) of the outer coating of the element should be less than or equal to the length (height) of the element. If it is less than the length (height) of the element, the element may have an area near the low temperature end that has a length not greater than 40% of the total length of the element and is left uncoated. The length (height) of the coating is determined by the length (height) of the element, the temperature of the high temperature end, the thickness of the coating, particularly of the M transitional layer, and the thermal properties of the skutterudite element core. In the case of a π-type device, if the coating length on the element surface is less than that of the element, the coatings on the p-type and n-type elements may have different lengths on condition that the operation temperatures of the uncoated parts of the two elements are close to each other.

A π-type device prepared according to the present disclosure has substantially improved durability and reliability during continuous use in high temperature environment. Despite slight decrease in thermoelectric conversion efficiency and electric power in comparison with a device constructed with an uncoated material, the device constituted by a coated material suffers from little degradation of properties after long-term (1000 hours) operation at high temperature (850K) in contrast to about 70% of decrease in thermoelectric conversion efficiency suffered by a device without coating protection after long-term operation at high temperature.

The high temperature evaporation of element Sb in the SKU material and the oxidation of SKU can be prevented effectively by the coating material. The main functions of the M layer include: (i) preventing element Sb from evaporation at high temperatures; and (ii) enhancing adhesion, compactness, consistency and binding strength of the MOₓ layer.

Unless otherwise specified, the various starting materials in the disclosure may be commercially available or prepared by any conventional method known in the art. Unless otherwise defined or specified, all special and scientific terms used herein have the meanings known by those skilled in the art. In addition, any process or material similar or equivalent to those cited herein may be used in the invention.

The invention will be explained in further detail with reference to the following specific examples. It is to be understood that these examples are provided only for the purpose of illustrating the invention without limiting the scope thereof. Generally, in the following examples, conventional conditions, or those suggested by manufacturers, will be followed where no specific conditions are given for an experiment. Unless otherwise specified, all ratios and percentages are based on weight, and polymeric molecular weights are number average molecular weights.

Unless otherwise defined or specified, all special and scientific terms used herein have the meanings known by those skilled in the art. In addition, any process or material similar or equivalent to those cited herein may be used in the invention.

### Example 1

A CoSb₃ based filled n-type skutterudite material, having a nominal composition of Ba_{0.24}CO₄Sb₁₂, was sintered into a block material which was then processed into a cuboid-shaped sample measuring 3×3×15 mm³. A NiCrMo coating (Ni:Cr:Mo=68:24:8) having a thickness of about 5 μm was formed on the surface of the sample by arc spraying, wherein the process parameters of the arc spraying include: arc voltage 28-30V, operation current 180-200 A, gas pressure 0.4-0.6 MPa, spraying distance 150-200 mm. Subsequently, a SiO₂ coating having a thickness of about 60 μm was formed on the NiCrMo coating by plasma spraying, wherein the process parameters of the plasma spraying include: spraying distance 70-100 mm, powder delivery rate 0.5-1 g/min, spraying current 70-100 A, ion gas Ar flow rate 1-1.5 L/min, powder delivery gas Ar flow rate 1-3 L/min.

### Example 2

A CoSb₃ based filled n-type skutterudite material, having a nominal composition of Ba_{0.18}Ce_{0.06}CO₄Sb₁₂, was sintered into a block material which was then processed into a cuboid-shaped sample measuring 3×3×15 mm³. An Al coating having a thickness of about 2 μm was formed on the surface of the sample by magnetron sputtering, wherein the Al target had a diameter of 75 mm and a thickness of 5 mm, and the sputtering gas was pure argon (with a purity of 99.999%) which had a flow rate of 15 mL/min. During the film sputtering, the background vacuum was 10 Pa, and the operation pressure was 0.2 Pa. In addition, the temperature of the sample was ambient temperature (20° C.), the sputtering power was 40 W, and the deposition rate of the thin film was about 12 nm/min. Finally, the sample with an aluminum coating was oxidized for 1 hour in air at 150° C. to form an Al₂O₃ coating on its surface.

### Example 3

This example was a π-type device composed of CoSb₃ based filled skutterudite elements having a multiple of concentric encapsulations. The p-type element and the n-type element have nominal compositions of Ce_{0.9}CO_{2.5}Fe_{1.5}Sb₁₂ and Yb_{0.3}CO₄Sb₁₂ respectively. The sintered block material was processed into a cuboid-shaped sample measuring 3×3×15 mm³. The p-type element and the n-type element were first covered at one end (including end face) with carbon paper for about 3.5 mm and 5.5 mm respectively, while the other ends were covered at the end face with the same material. The exposed surface of each of the two elements was sprayed with a Mo coating of about 6 μm thick by arc spraying, and then a ZrO₂ coating of about 20 μm thick was sprayed on the Mo coating by plasma spraying. Finally, the carbon paper was removed, and a p-type element and an n-type element having a coating length of 16.5 mm and 14.5 mm respectively were obtained (see FIG. 4).

All references mentioned in this disclosure are incorporated herein by reference, as if each of them would be incorporated herein by reference independently. In addition, it is to be appreciated that various changes or modifications can be made to the invention by those skilled in the art who have read the content taught above. These equivalents are intended to be included in the scope defined by the appended claims of the application.

We claim:

1. A coating, which is suitable for thermoelectric material, comprising
a thermoelectric layer comprising a thermoelectric material;
a metal coating of one or more layers, wherein the metal coating forms a surface in contact with said thermoelectric layer and as well as an opposing surface;
a metal oxide coating of one or more layers, comprising metal oxides, wherein said metal oxide coating forms a surface in contact with said opposing surface.

2. The coating of claim 1, wherein said thermoelectric material is selected from filled and/or doped skutterudite.

3. The coating of claim 2, wherein said filled and/or doped skutterudite is selected from CoSb₃ based skutterudite.

4. The coating of claim 1, wherein said metal coating(s) comprises Ta, Nb, Ti, Mo, V, Al, Zr, Ni, NiAl, TiAl, NiCr or a combination thereof.

5. The coating of claim 1, wherein said metal oxide coating(s) comprises TiO₂, Ta₂O₅, Nb₂O₅, Al₂O₃, ZrO₂, NiO, SiO₂ or a combination thereof.

6. The coating of claim 1, wherein the coating has a thickness of 10-500 μm.

7. The coating of claim 6, wherein the coating has a thickness of 50-200 μm.

8. The coating of claim 1, wherein said metal coating(s) has a thickness of 0.01-20 μm.

9. The coating of claim 8, wherein said metal coating(s) has a thickness of 0.2-2 μm.

10. The coating of claim 1, wherein said thermoelectric layer has a height of L_{T}, and said metal coating(s) and said metal oxide coating(s) each has a height of L_{M&MOx}, wherein L_{M&MOx}≦L_{T}, and (L_{T}−L_{M&MOx})/L_{T}≦0.4.

11. A device comprising the coating of claim 1.

12. A process for fabricating the coating of claim 1, comprising
providing a thermoelectric layer comprising a thermoelectric material;
forming a metal coating of one or more layers on said thermoelectric layer, wherein said metal coatings forms a surface in contact with said thermoelectric layer as well as an opposing surface;
forming a metal oxide coating of one or more layers comprising a metal oxide on said metal coating(s), wherein said metal oxide coatings form a surface in contact with said opposing surface of said metal coating(s).

13. The process of claim 12, comprising
forming all or a portion of said metal coatings by thermal evaporation, arc spraying, plasma spraying, flame spraying, vacuum sputtering, electrochemical vapor deposition, electric plating or electroless deposition.

14. The process of claim 12 for fabricating said layer, comprising
forming all or a portion of said metal oxide coatings by thermal evaporation, vacuum sputtering, plasma spraying, sol-gel, chemical solution deposition or chemical vapor deposition.

15. The process of claim 12 for fabricating said layer, comprising
at least partially oxidizing said metal coating, to form said metal oxide coating in contact with said opposing surface of said metal coating.
